(19) United States
(12) Patent Application Publication
(10) Pub. No.: US 2026/0369804 A1
(43) Pub. Date: Nov. 19, 2026

(54) METHOD FOR MANUFACTURING POROUS FILM, POROUS FILM MANUFACTURED THEREBY AND SECONDARY BATTERY SEPARATOR OR SECONDARY BATTERY COMPRISING SAME

(71) Applicant: Sunghee AHN, Seoul (KR)

(72) Inventor: Sunghee AHN, Seoul (KR)

(21) Appl. No.: 19/470,856

(22) PCT Filed: Apr. 3, 2024
(86) PCT No.: PCT/KR2024/004348

§ 371 Date: Sep. 30, 2025

(30) Foreign Application Priority Data
Apr. 4, 2023 (KR) 10-2023-0043878

(51) Int. Cl. H01M 50/414; H01M 10/0525; H01M 50/403; H01M 50/491

(52) U.S. Cl. CPC H01M 50/414; H01M 10/0525; H01M 50/403; H01M 50/491

(57) ABSTRACT

The present invention relates to a method for manufacturing a porous film, a porous film manufactured by the method, and a secondary battery separator or secondary battery containing the same. The method comprises: a) mixing and melting a crystalline resin capable of forming lamellae with pore-forming particles to produce a crystalline resin mixture containing pore-forming particles, b) melting and extruding the resin mixture to form a precursor film, c), d), e) annealing the precursor film, performing a first stretching, and a second stretching, f) heat setting the film after the second stretching to manufacture a porous film, wherein the temperature of the crystalline resin mixture containing pore-forming particles in steps a) and b) is maintained below 250 °C. The present invention also relates to a porous film manufactured by the method, and a secondary battery separator or secondary battery containing the porous film.

### TECHNICAL FIELD

The present invention relates to a method for manufacturing a porous film, a porous film manufactured thereby, and a secondary battery separator or secondary battery comprising the same. More specifically, the invention relates to a method for producing a porous film by mixing and melting a crystalline resin capable of forming lamellae with pore-forming particles to prepare a crystalline resin mixture containing pore-forming particles, followed by sequential steps of precursor film formation, annealing, first stretching, secondary stretching, and heat setting. The invention further relates to the porous film produced thereby and a secondary battery separator or a secondary battery comprising the same.

### BACKGROUND ART

Lithium-ion batteries (LIBs), which can undergo repeated charging and discharging, were first commercialized in 1991. Due to their high energy density, absence of memory effect, and low self-discharge rate when not in use, LIBs have seen rapid expansion in applications such as smartphones, power banks, portable speakers, digital cameras, power tools, electric scooters, aircraft, automated equipment, and energy storage systems. Particularly, as part of efforts to reduce global warming, electric vehicles have emerged as a promising alternative to internal combustion engines, driving explosive growth in the EV market.

A battery cell, the smallest unit of a lithium-ion battery, consists of four main components: cathode, anode, separator, and electrolyte. These components participate in energy storage and release through repeated charge and discharge cycles. Lithium ions move between the cathode and anode during these cycles. The cathode, typically composed of lithium oxides, exists in a stabilized oxidized form where lithium is bound to oxygen. During charging, oxidation occurs at the cathode, releasing lithium ions, while reduction occurs during discharge, absorbing lithium ions. The anode, usually made of graphite or silicon compounds, absorbs lithium ions and electrons during charging and releases them during discharging. The separator physically separates the cathode and anode to prevent direct contact while allowing lithium-ion transport through its microporous structure. The electrolyte, typically a liquid organic compound, acts as a medium for ionic movement between the cathode and anode during redox reactions.

Among these four components, the separator plays a critical role in ensuring safety and enabling lithium-ion movement. Currently, commercial separators are primarily produced by two methods, each yielding distinct quality characteristics. It must possess small and uniformly distributed pores and high porosity to meet the required performance standards.

On the other hand, although various processes are available for forming pores in very thin plastic films, methods for forming micropores of less than 1 μm are generally classified into three representative processes. Each microporous film manufactured by these processes exhibits markedly different physical properties depending on the manufacturing method (see Resting, R., Synthetic Polymeric Membranes, A Structural Perspective, Second Edition, John Wiley & Sons, New York, NY, 1985). The three processes capable of commercial production of microporous films include: the wet process, the particle stretch process (mainly used for producing breathable particles), and the dry-stretch process, which was developed and commercialized by Celgard.

In general, in the wet process—also referred to as the phase inversion process (Temperature Induced Phase Separation), the extraction process, or the TIPS process—a polymeric raw material is mixed with a processing oil (also referred to as a plasticizer or pore-forming agent), and the mixture is extruded. Pores are then generated when the processing oil is removed. The resulting film may be stretched either before or after the removal of the oil (see Resting, Ibid, pp. 237-286).

A microporous film produced by the wet process generally has pores similar to circular shapes, since the film composed of the polymer and processing oil can be stretched in both the transverse direction (TD) and the machine direction (MD). In practice, multilayered circular pores are formed in a composite manner, resulting in a characteristic two-dimensional disordered structure. Typically, such films exhibit uniform physical surface pores of about 200 nm and nominal pores of 0.03 μm to 0.06 μm, which provide pore size and distribution suitable for use as separators in secondary batteries. The pore size and porosity may be controlled by employing polymers having relatively low molecular weight, increasing the stretching ratio, and raising the processing temperature, all of which increase pore size and porosity. In particular, due to the relatively high biaxial stretching ratio compared to other processes, such microporous films exhibit very high strength in both the transverse and longitudinal directions. When high molecular weight polymers are employed, the strength is significantly enhanced, and the films are generally produced such that the ratio of transverse-to-longitudinal strength approaches 1.0.

In this connection, Korean Patent No. 10-1512145 B1 assigned to LG discloses that, in the production of a separator by the wet process, although a high content of a processing oil is generally required to improve air permeability, an excessive content may adversely affect the strength of the finally produced separator sheet. Accordingly, the processing oil is included in an amount of 60 wt % to 70 wt %. In this case, the pore-forming agent is selected from hydrocarbon-based solvents, vegetable oils, and plasticizers, whereas the use of inorganic particles as the pore-forming agent is scarcely adopted.

Despite the clear characteristics of the above-described processes, some technologies have attempted to introduce particles in order to improve insufficient properties. For example, the technique of introducing particles to enhance air permeability in wet separators can be observed in the embodiments of Japanese Patent No. 5295834 B2. In the case where only a polymer is employed to provide a separator, the nominal pore size of the separator is 0.04 μm to 0.09 μm and the porosity is 40% to 47%. However, in a separator into which an inorganic particle such as silica is introduced, the nominal pore size is 0.13 μm to 0.21 μm and the porosity is 45% to 60%, indicating the general phenomenon in which both pore size and porosity increase simultaneously. Since the silica particles introduced into the wet process to improve porosity are dispersed in a polymer solution mainly containing a low-molecular-weight pore-forming agent as a dispersion medium, the thermodynamic influence is relatively small compared to dry separator materials having a high molecular weight. Therefore, even particles with a small diameter can be easily dispersed, and no special conditions are required for the dispersion process. However, such added inorganic particles, when remaining inside the porous film, provide no particular advantages, while instead increasing the process cost of the separator and enlarging the pore size, thereby reducing the separation performance of the wet separator. Accordingly, the actual application of such particles to the process is rarely adopted.

Secondly, there is the particle stretch process for producing a microporous film. In this process, a polymeric raw material is mixed with particulates, and the mixture is extruded. Pores are then formed when the interfacial boundaries between the polymer and the particulates are disrupted by a stretching force. Since the precursor without pores can be produced without any process limitations related to the formation of specific crystals or the control of structures, the selection of the polymer material is mainly focused on processability. Therefore, it is difficult to obtain a uniform fine repetitive structure at a level suitable for use as a separator in the microporous film formed after stretching. Furthermore, in view of manufacturing convenience, the particle size of the particulates to be employed is typically designed to have an average particle diameter of 1 μm to 3 μm. Because pores are formed from such precursors, the pore size distribution becomes broad and the average pore diameter is relatively large, extending from several micrometers to several tens of micrometers. Thus, when used as a microporous membrane for secondary batteries, the resulting film has limitations in separation performance. FIG. 1 shows a scanning electron microscope (SEM) image of a microporous film produced by the particle stretch process in which pores were formed using nanoparticles of 40 nm. Based on the scale bar, elliptical pores measuring several m were observed, and the pores had a much larger size compared with that of the particles. This confirms that the introduction of fine nanoparticles of nanometer size does not necessarily lead to a reduction in pore size.

In addition, a membrane stretched with introduced particles has its generated pores filled with the particulates required for pore formation, and in many cases where the intended application is mainly for hygienic products, there is no need to remove such particles. For the production of particle-stretched microporous films, either a uniaxial or biaxial stretching process is applied depending on the required properties of the final product. However, the ultimate strength is relatively lower compared to that of wet separators, since the polyolefin employed has a lower molecular weight and the stretching ratio as well as the stretching balance between the transverse direction (TD) and the machine direction (MD) are different. Consequently, the transverse strength is anisotropic, being about 15% to 40% of the strength in the machine direction.

Finally, the dry-stretch process refers to a process in which pores are formed by stretching a nonporous precursor (see Resting, Ibid, pp. 290-297). The dry-stretch process is distinct from the wet process and the particle stretch process. A microporous film produced by the dry-stretch process has characteristic slit-shaped pores, since the precursor is not stretched in the transverse machine direction. In the case of pore formation by the uniaxial dry-stretch method, also known as the Celgard method, it has been reported that the crystalline structure of the precursor film has a decisive influence on the pore uniformity of the resulting microporous film. Accordingly, in most production processes, no pore-forming agent is added. Further, in order to form a specific structure, namely a folded lamellar crystalline layer structure, for pore formation, precursor formation conditions are controlled such that the precursor has a high draw ratio. Through this process, the thickness of a single lamella crystal of the polymer formed is known to be about 10 nm to 40 nm, depending on processing conditions. The pores generated by stretching generally form a fibril structure of about 200 nm between lamella layers, wherein each lamella layer is composed of about 10 to 20 lamella crystals. The distance between adjacent fibrils is about 30 nm to 50 nm, thereby forming narrow, elongated slit-shaped pores of elliptical or rectangular form (see FIG. 2). During stretching, the strength of the portion of the precursor film where pores are formed increases such that further stretching does not occur, and the unstretched portions are subsequently stretched. This strain-hardening behavior allows the formation of uniform pores throughout the film, thereby providing pore size and pore size distribution suitable for use as a separator in secondary batteries. However, a microporous separator produced by the uniaxial dry-stretch method has a drawback in that, because it is not stretched laterally in the transverse direction, its strength in the transverse direction is only about one-tenth of that in the machine direction. Due to this limitation, its applicability to a wide range of uses is restricted.

To improve the strength in the transverse direction, a newly developed method, namely the dry biaxial stretch separator, has been introduced. As disclosed in Celgard's Korean Patent No. 10-2008-0085922 A, this method developed by Celgard is distinguished from particle-introduced pore formation processes in that it begins with forming a precursor film without any additives for pore formation. A particular feature of this process is that the resulting microporous film exhibits pores substantially similar in form to those of wet separators, and the ratio of machine direction tensile strength to transverse tensile strength is improved, while no particles are included within the generated pores. However, in the case of such a biaxial stretch process, although the resulting pore volume fraction is relatively high (about 40% to 63%), the physical surface pores are excessively large, exceeding 300 nm (see FIG. 3), which limits the separation performance when applied to secondary batteries, and thus the method is not widely adopted for battery separators. With respect to particle introduction, as can be seen in an improved Celgard process disclosed in SKC's Korean Patent No. 2012-0075835 A, the content of additives for pore formation must be maintained below 1 wt %. This is because, if an excessive amount of additives is introduced, the pores generated from the excessive additive particles grow to a size that, similar to the particle-introduced stretch process described above, cannot be effectively controlled, thereby imposing limitations.

As described above, the manufacturing technologies of separators by the wet process, particle stretch process, and dry-stretch process are independent and distinct. In cases where parts of these technologies are inadvertently combined, the properties of the resulting porous film—such as uniformity and productivity—may be inferior compared to films produced by the original processes, or the pores may become enlarged, thereby reducing the separation performance. From this perspective, the three separator manufacturing processes can be classified as completely independent and distinct porous film production technologies.

In a separator manufacturing process having such characteristics, Samsung SDI filed Korean Patent No. 10-2017-0029399 A, in which an attempt was made to introduce particles to finely control the pore size in a uniaxial stretch separator process. In this patent, particles having a size smaller than the typical inter-lamellar spacing observed in a uniaxial stretch process are introduced to position the particles within the lamella layers. The extrusion conditions of the precursor are restricted to generate an appropriate layered lamellar crystalline structure. By subsequently stretching, pores smaller and more uniform than those achievable by the conventional uniaxial dry-stretch separator process can be formed, while limiting the formation of large-scale stretch-induced pores that may occur in particle-introduced stretch processes. A comparable technology is disclosed in Japanese Unexamined Patent Publication 2009-211946 A, wherein large-diameter particles are introduced in small amounts to form longitudinal pores larger than 0.5 μm inside the porous separator, thereby reducing resistance. From the scanning electron microscope images disclosed in the specification, particles of 0.2 μm to 0.4 μm do not form a uniform distribution, and many particles appear aggregated. This indicates that appropriate surface treatment for particle dispersion was not performed and that the mixing conditions for achieving uniform dispersion in the molten blend were not properly set. Such pores act as defects that shorten the lifespan of the separator. Accordingly, when the particle content is increased, the effect often manifests as a reduction in separation performance rather than a decrease in resistance.

Moreover, in the above-mentioned technology, the particles introduced are too large to affect the pore structure formed by the lamella and fibril layers in conventional dry separators. As a result, the micropores of the porous film are comparable to those of uniaxial dry-stretch separators, which is distinct from the technology disclosed in Samsung SDI's patent. In Samsung SDI's patent, the core of the technology lies in introducing particles smaller than 300 nm to further refine the lamella-fibril structure formed in the conventional dry process, thereby reducing the pore size. Accordingly, the patent discloses that introducing particles larger than 300 nm cannot achieve such pore refinement. In other words, if the condition in Samsung SDI's technology were such that 0.5 m longitudinal pores are generated by particle introduction, the lamella-fibril structure would remain the same as in the conventional dry process, which is fundamentally different from the technology disclosed by Samsung SDI. If Japanese Unexamined Patent Publication 2009-211946 A had considered the technology for pore refinement, the particle size would have been limited to smaller dimensions, and the most preferred particle content would have been controlled at higher levels, as in Samsung SDI's technology, rather than 1.5 vol % to 10 vol %. This is because, in the field of microporous separators, technologies capable of achieving pore refinement are of critical importance and have the potential to develop into new industries. Through such limitations, Samsung SDI's technology enables the formation of a finer pore structure compared to conventional dry porous separators. That is, although the pores contain particles as in the particle stretch process, the technology achieves smaller pore sizes and more uniform pore distribution compared to uniaxial stretch separators, thereby enabling the use of the film as a separator for secondary batteries.

Meanwhile, when a precursor film is formed by introducing particles and subsequently subjected to uniaxial stretching, the uniformity of particle dispersion within the precursor has not been fully specified, although it is discussed in detail in Samsung SDI's Korean Patent No. 10-2017-0029399 A. Unlike conventional polymer processing, in which fillers with sizes on the order of micrometers are dispersed in the polymer, the technology in question employs nanoparticles, which introduces additional constraints on particle characteristics and processing conditions. Furthermore, since the precursor film must be formed as a thin film composed of a mixture of nanoparticles and polymer, additional process condition limitations are imposed. This phenomenon arises because the thermodynamic and kinetic driving forces in the nanoparticle dispersion compete with each other, thereby determining the structure of the dispersion. In other words, the dispersion state of the nanoparticles and the lamella-forming crystalline polymer used to form the precursor film becomes the most critical factor in determining the quality of the final porous film. Accordingly, the present application aims to improve pore uniformity in particle-introduced uniaxial stretch separators and enhance battery lifespan by implementing a method for dispersing nanoparticles in accordance with the above requirements and further restricting the conditions during precursor production.

Accordingly, the present application seeks to improve the pore uniformity of particle-introduced uniaxial stretch separators and enhance battery lifespan by implementing a method for dispersing nanoparticles in accordance with the above requirements and by further restricting the conditions during precursor production.

### PRIOR ART DOCUMENT

### Patent Document

(Patent Document 1) Korean Registered Patent Publication No. 10-1512145 B1 (Registration Date: Apr. 8, 2015)
(Patent Document 2) Japanese Unexamined Patent Publication No. 2009-211946 A (Publication Date: Sep. 17, 2009)
(Patent Document 3) Japanese Registered Patent No. 5295834 B2 (Registration Date: Sep. 18, 2013)
(Patent Document 4) Korean Unexamined Patent Publication No. 10-2008-0085922 A (Publication Date: Sep. 24, 2008)
(Patent Document 5) Korean Unexamined Patent Publication No. 2012-0075835 A (Publication Date: Jul. 9, 2012)
(Patent Document 6) Korean Unexamined Patent Publication No. 10-2017-0029399 A (Publication Date: Mar. 15, 2017)

### Non-Patent Document

(Non-Patent Document 1) Resting, R., Synthetic Polymeric Membranes, A structural perspective, Second Edition, John Wiley & Sons, New York, NY, (1985)

### DISCLOSURE OF INVENTION

### Technical Problem

The present invention aims to provide a method for manufacturing a porous film suitable for use as a separator in secondary batteries using a particle-dispersed uniaxial dry stretching process. By limiting the materials and processing conditions of the porous film, the invention overcomes the drawbacks of large pore size and low mechanical strength found in porous films produced by conventional wet, particle-stretch, and dry-stretch processes. Furthermore, it improves particle dispersion to enable finer pore formation and enhances pore uniformity. The invention also provides the porous film manufactured using this method, as well as a secondary battery separator and a secondary battery including the same.

### Solution to Problem

A method for producing a porous film according to an embodiment of the present invention comprises: a) a resin mixture manufacturing step of mixing and melting a crystalline resin capable of forming lamellae with pore-forming particles to prepare a crystalline resin mixture containing the pore-forming particles, while maintaining the temperature of the mixture below 250 °C during the mixing and melting; b) a precursor film manufacturing step of preparing a precursor film containing the pore-forming particles by adjusting the extrusion amount and take-up speed such that the draw ratio is 50 or more, using the crystalline resin mixture prepared in the resin mixing step, while maintaining the temperature of the mixture below 250 °C during precursor film formation; c) an annealing step of annealing the precursor film formed in the precursor film forming step at a temperature of 90 °C to (Tm-3°) C; d) a first stretching step of stretching the annealed precursor film from the annealing step by 5% to 140% at a temperature of 0 °C to 65 °C to produce a porous film; e) a second stretching step of further stretching the porous film stretched in the first stretching step by 0% to 400% at a temperature of 80 °C to (Tm-3°) C; and f) a heat-setting step of heat-setting the porous film stretched in the second stretching step at a temperature of 90 °C to (Tm-3°) C.

In an embodiment of the present invention, the method further comprises: g) a pore-forming particle removal step of removing the pore-forming particles from the porous film after the heat-setting step.

In an embodiment of the present invention, the resin mixture manufacturing step comprises using inorganic particles, organic particles, or a combination thereof as the pore-forming particles.

In an embodiment of the present invention, the resin mixture manufacturing step comprises using pore-forming particles having an average particle size of 3 nm to 300 nm.

In an embodiment of the present invention, the resin mixture manufacturing step comprises incorporating the pore-forming particles in an amount of 3 vol % to 30 vol % based on the total volume of the crystalline resin mixture containing the pore-forming particles.

In an embodiment of the present invention, the resin mixture manufacturing step comprises using a semi-crystalline polymer as the crystalline resin capable of forming lamellae.

In an embodiment of the present invention, the semi-crystalline polymer is polyethylene or polypropylene.

In another embodiment of the present invention, the porous film is produced by the manufacturing method described above.

In another embodiment of the present invention, a separator for an electrochemical cell is produced from the porous film manufactured by the above-described method.

In another embodiment of the present invention, an electrochemical cell comprises a separator produced from the porous film manufactured by the above-described method, a positive electrode, a negative electrode, and an electrolyte.

In an embodiment of the present invention, the electrochemical cell is an alkaline secondary battery.

In an embodiment of the present invention, the electrochemical cell is a lithium secondary battery.

### Advantageous Effects of Invention

The present invention relates to a method for producing a porous film, a porous film produced thereby, and a secondary battery or a separator for a secondary battery comprising the same. In producing a porous film applicable as a separator for a secondary battery using a uniaxial dry-stretch process, a mixture is prepared in which pore-forming particles are dispersed in a crystalline resin capable of forming lamellae according to the process conditions of the present invention. Using the mixture, a precursor film is formed, followed by annealing, first stretching, second stretching, and heat-setting steps to produce a porous film. By this method, it is possible to produce a porous film having refined pore sizes, improved porosity, and enhanced strength suitable for use as a secondary battery separator. In particular, by maintaining the temperature of the mixture below 250 °C during the mixture preparation and precursor film formation steps, the dispersion of particles on the precursor film is improved. Consequently, after stretching the precursor film into a fine porous film, the pore uniformity is enhanced, resulting in a porous film of stable quality. Moreover, when the porous film produced in this manner is used as a separator in a secondary battery, the battery can achieve an improved service life.

### BRIEF DESCRIPTION OF DRAWINGS

FIG. 1 is an electron microscope photograph of a fine porous film produced by the particle stretch process, in which pores are formed using 40 nm nanoparticles.

FIG. 2 is an electron microscope photograph of a fine porous film produced by a dry uniaxial stretch process.

FIG. 3 is an electron microscope photograph of a fine porous film produced by a dry biaxial stretch process.

FIG. 4 is a flowchart illustrating a method for producing a porous film according to an embodiment of the present invention.

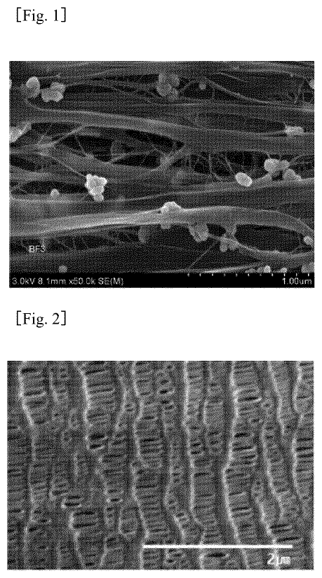

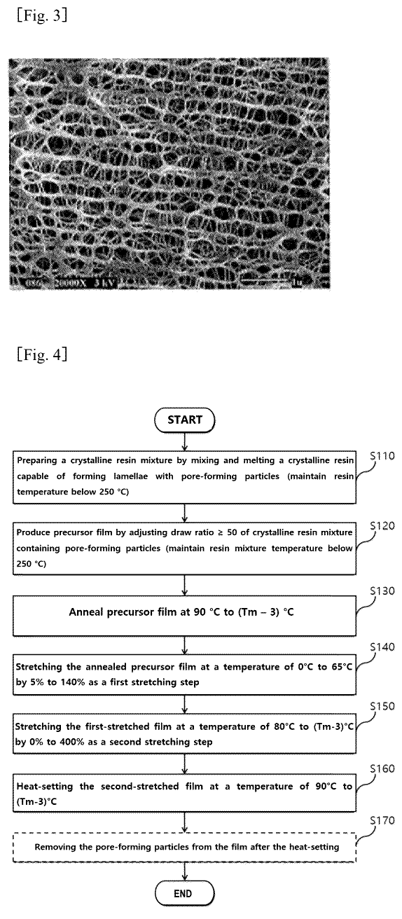

### MODE FOR CARRYING OUT THE INVENTION

Unless otherwise defined, all technical and scientific terms used in this specification have the same meaning as commonly understood by those skilled in the relevant technical field. In general, the nomenclature used in this specification is well-known and commonly used in the field of technology to which this invention pertains.

Throughout this specification, when a part is said to “include” certain components, it means that, unless explicitly stated otherwise, the part may include other components as well, not excluding any additional components. Tm refers to the melting temperature.

As the content not described in this specification can be reasonably inferred by someone skilled in the relevant technical field or similar fields, the explanation is omitted.

The present invention relates to a method for manufacturing a porous film, the porous film manufactured thereby, and a secondary battery separator or secondary battery including the porous film. The method involves mixing and melting a crystalline resin capable of forming lamellae with pore-forming particles to prepare a crystalline resin mixture containing the pore-forming particles, which is then used to produce a precursor film, followed by annealing, first stretching, second stretching, and heat-setting to produce a porous film. The present invention also includes the porous film and the secondary battery separator or secondary battery containing the porous film.

Below, the method for manufacturing a porous film according to an embodiment of the present invention will be described.

FIG. 4 is a flowchart illustrating the method for manufacturing a porous film according to an embodiment of the present invention.

As shown in FIG. 4, the method for manufacturing the porous film includes the following steps: resin mixture manufacturing, precursor film manufacturing, annealing, first stretching, second stretching, heat-setting, and pore-forming particle removal.

The resin mixture manufacturing step comprises mixing and melting a crystalline resin capable of forming lamellae with pore-forming particles to prepare a crystalline resin mixture containing the pore-forming particles, while maintaining the temperature of the mixture below 250 °C during the mixing and melting. In one embodiment, pellets may be prepared during the resin mixing step and used in the subsequent process. In another embodiment, the molten mixture may be directly applied to the precursor formation step without producing pellets.

The precursor film manufacturing step comprises preparing a precursor film containing the pore-forming particles by using a casting roll set at a temperature of (Tm-100°) C to (Tm-10°) C and adjusting the extrusion amount and take-up speed such that the draw ratio is 50 or more, using the crystalline resin mixture containing the pore-forming particles prepared in the resin mixture manufacturing step, while maintaining the temperature of the mixture below 250 °C during precursor film manufacturing.

The annealing step comprises annealing the precursor film formed in the precursor film forming step at a temperature of 90 °C to (Tm-3°) C.

The first stretching step comprises stretching the annealed precursor film from the annealing step by 5% to 140% at a temperature of 0 °C to 65 °C to produce a porous film.

The second stretching step comprises further stretching the porous film stretched in the first stretching step by 0% to 400% at a temperature of 80 °C to (Tm-3°) C.

The heat-setting step comprises heat-setting the porous film stretched in the second stretching step at a temperature of 90 °C to (Tm-3°) C.

In addition, the method for producing a porous film according to the present invention may further comprise a pore-forming particle removal step of removing the pore-forming particles from the porous film after the heat-setting step.

Hereinafter, each step of the method for producing a porous film according to the present invention will be described in greater detail.

As described above, the resin mixing step comprises mixing and melting a crystalline resin capable of forming lamellae (hereinafter, “lamella-forming crystalline resin”) with pore-forming particles to prepare a crystalline resin mixture containing the pore-forming particles.

The lamella-forming crystalline resin is preferably a semi-crystalline polymer, and the semi-crystalline polymer is more preferably polyethylene or polypropylene.

In addition, the pore-forming particles may be inorganic particles, organic particles, or a combination thereof. The inorganic particles may include one or more selected from the group consisting of alumina, silica, titania, zirconia, magnesia, ceria, zinc oxide, iron oxide, silicon nitride, titanium nitride, boron nitride, calcium carbonate, barium sulfate, aluminum sulfate, aluminum hydroxide, barium titanate, calcium titanate, talc, calcium silicate, and magnesium silicate.

In addition, the organic particles may be a polymer of a monomer containing a conjugated double bond prepared by emulsion polymerization or suspension polymerization, a crosslinked polymer, or one or more polymer precipitates formed in solution through solubility control. More specifically, the organic particles may include one or more selected from the group consisting of non-crosslinked or crosslinked polystyrene (PS), polyethylene (PE), polypropylene (PP), polyvinylidene fluoride (PVdF), polytetrafluoroethylene (PTFE), polyurethane (PU), polymethylpentene (PMP), polyethylene terephthalate (PET), polycarbonate (PC), polyester, polyvinyl alcohol (PVA), polyacrylonitrile (PAN), polymethylene oxide (PMO), polymethyl methacrylate (PMMA), polyethylene oxide (PEO), polyamide (PA), silicone-acrylic rubber, ethylene-methyl acrylate copolymer, polyamide-imide (PAI), polysulfone (PSF), polyethersulfone (PES), polyphenylene sulfide (PPS), polyarylate (PAR), polyimide (PI), polyaramid (PA), cellulose, cellulose derivatives, melamine resins, and phenolic resins. Preferably, the organic particles may include one or more selected from crosslinked silicone-acrylic rubber, ethylene-methyl acrylate copolymer, polystyrene (PS), polyethylene (PE), polypropylene (PP), polysulfone (PSF), and polyimide (PI). More preferably, the organic particles may include one or more selected from crosslinked silicone-acrylic rubber, ethylene-methyl acrylate copolymer, polystyrene (PS), or polymethyl methacrylate (PMMA).

In addition, the size of the pore-forming particles may be 0.1 to 50 times the thickness of the lamellar crystals formed from the crystalline resin. More preferably, the size of the pore-forming particles may be 0.1 to 30 times the lamellar crystal thickness. Even more preferably, it may be 0.1 to 5 times the lamellar crystal thickness. Preferably, the average particle diameter of the pore-forming particles may be 3 nm to 300 nm. More preferably, it may be 3 nm to 250 nm, even more preferably 3 nm to 200 nm, and most preferably 3 nm to 100 nm. When the size of the pore-forming particles is smaller than 3 nm, uniform dispersion within the polymer is difficult. When the particle size exceeds 300 nm, although dispersion is not problematic, the particles are excessively large relative to the lamellar crystal layers formed in a uniaxially drawn dry separator, which is the purpose of their introduction. As a result, instead of achieving the desired fine pores, large pores may be formed on the surface and inside the separator, reducing pore uniformity and thereby decreasing the separation performance. This may lead to a shortened lifespan when used in secondary batteries. Therefore, by using pore-forming particles within the above size range, advantages can be obtained in terms of pore size control, pore uniformity, and air permeability.

In addition, based on the total volume of the crystalline resin mixture containing the pore-forming particles, the pore-forming particles may be included in an amount of 3 to 30 vol %, preferably 3 to 27 vol %, and more preferably 5 to 25 vol %. Since the content of the introduced particles is relatively high, ensuring the dispersion of the pore-forming particles in the precursor film serves as the most critical factor for achieving the desired separation properties.

When the content of the pore-forming particles is less than 3 vol %, the amount of first pores generated by the pore-forming particles is insufficient, resulting in the formation of second pores similar in size to those of conventional uniaxially drawn dry separators, making it difficult to observe the effect of particle introduction. The first pores and second pores will be described in detail in the subsequent stretching steps.

When the pore-forming particles are included in the above range in the precursor composition, the second pores generated by the first pores can be finer and more uniform, improving the separation properties and air permeability of the resulting porous film. If the content of the pore-forming particles exceeds 30 vol %, the viscosity of the resin mixture becomes excessively high, making it difficult to process the composition into a film. Even if the dispersion of the pore-forming particles is maintained within the material, the distance between particles becomes too small, causing the particles to behave collectively like a macro-scale aggregate rather than as fine particles. As a result, large primary pores are generated, which may hinder the achievement of desired separation properties in the porous film.

Meanwhile, since the size of the pore-forming particles is limited to particles smaller than 300 nm, it is necessary to treat the particle surfaces with a surfactant or the like to render them hydrophobic in order to ensure proper dispersion. When conventional methods for improving dispersibility, such as adding a surfactant or mechanically pre-mixing the surfactant with the particles, are applied, it is very difficult to achieve an appropriate level of dispersion when mixing with the lamella-forming crystalline resin. Therefore, the surface treatment must be performed under a highly controlled process. One method for preliminarily evaluating the degree of hydrophobic surface treatment of the pore-forming particles is a precipitation test using n-hexane. A small amount of appropriately hydrophobically treated particles is scattered on the surface of n-hexane in a beaker, and if all the particles precipitate without remaining on the surface, it can be determined that the particle surfaces have been properly rendered hydrophobic.

Particles that pass the preliminary evaluation can have their dispersion further assessed after being kneaded with the actual lamella-forming crystalline material. This can be done by transmitting the pellets through an X-ray detector to evaluate the degree of particle agglomeration, or by forming a precursor film and measuring the number and size of agglomerates present within the film or defects appearing on the film surface. Additionally, in the microporous film formed after stretching, the number and size of defects can also be analyzed to identify defects related to particle dispersion, thereby providing information on the dispersibility of the particles. Another method for evaluating dispersibility is to take images of the dispersed and continuous phases in the precursor film using transmission electron microscopy (TEM) and observe the particle distribution.

In addition, the resin mixture may, if necessary, contain at least one of an antioxidant, an antistatic agent, a neutralizer, a dispersant, an antiblocking agent, or a slip agent in a predetermined amount.

As described above, in the precursor film manufacturing step, the crystalline resin mixture containing the pore-forming particles, prepared in the resin mixture manufacturing step, is processed using a casting roll set at a temperature of (Tm-100)°C to (Tm-10)°C, and the extrusion amount and take-up speed are adjusted so that the draw ratio is 50 or higher, thereby forming a precursor film containing the pore-forming particles.

At this time, in the resin mixture manufacturing step and the precursor film manufacturing step, the temperature of the resin mixture is maintained below 250 °C throughout the entire process, preferably at 240 °C or lower, and more preferably at 230 °C or lower.

As described above, the reason for maintaining the temperature of the resin mixture below 250 °C in the method for producing a porous film according to the present invention is as follows.

In the resin mixture manufacturing step, the hydrophobic pore-forming particles are melt-blended with the lamella-forming crystalline resin at high temperatures. uring this melt-blending, despite the hydrophobic surface treatment, the pore-forming particles and the lamella-forming crystalline resin tend to continuously aggregate due to thermodynamic driving forces as the resin temperature increases.

Therefore, the thermodynamic driving force that promotes aggregation must be minimized while the kinetic driving force that maximizes dispersion is balanced. To achieve this, the temperature of the resin mixture must be maintained below 250 °C. This temperature control is equally applicable to both the resin mixture pellet preparation step and the precursor film manufacturing step.

In the prior art, the temperature conditions corresponding to the resin mixture manufacturing step and the precursor film manufacturing step according to the present invention are limited to the set temperatures of equipment such as mixers, extruders, and dies. However, during the process, the actual temperature of the resin composition increases above the set temperature of the equipment due to factors such as the high content of particles, the viscosity of the composition, the pressure within the processing equipment, and the frictional heat generated by the stirring speed. Therefore, the process temperature conditions in the prior art differ from the actual temperature of the resin composition.

Furthermore, in the prior art, even when particles are introduced in wet processes, the environment in which the particles are dispersed is essentially a polymer solution containing a solvent. Under these conditions, the hydrophobically treated particles do not exhibit LCST behavior at elevated temperatures, and thus the dispersion is maintained.

In contrast, in the dry-type separator manufacturing process, where relatively large particles are dispersed in a lamella-forming polymer, the surface area of the dispersed particles is small. Therefore, the thermodynamic phase-separation effect—i.e., the reduction in dispersibility due to temperature—is not significantly observed, and the kinetic effect, namely dispersion due to shear stress, is generally more pronounced. Moreover, when the particle content is low, even if the dispersion is not perfectly uniform, it can be considered relatively homogeneous, and the impact of dispersibility on the final properties of the separator is minimal. Consequently, under typical processing conditions, achieving particle dispersion as a target is relatively straightforward. As a result, the main focus of the dispersion process is typically on the productivity of the dispersed material, and the system is configured for high-speed production at elevated temperatures. This is illustrated in Japanese Patent Publication 2009-211946 A, where, despite the use of large 0.3 μm particles, the dispersed state is not of individual particles but exists as aggregates composed of multiple particles.

On the other hand, when nanoparticles are dispersed in a lamella-forming polymer, their surface area becomes hundreds of times larger than that of particles with a size on the order of micrometers, and consequently phase separation is observed to be promoted with increasing temperature, following LCST (Lower Critical Solution Temperature) behavior. This LCST behavior becomes more pronounced as the particle size decreases; therefore, in polymer systems where nanoparticles are dispersed, the key technical challenge is to secure dispersion while preventing the system from reaching the LCST. The hydrophobicity of the particle surface also has a significant influence on such dispersion. Even when hydrophobic surface treatment has been carried out, the surface hydrophobicity is not completely perfect, and because the mixed materials are polymers such as polyethylene or polypropylene, which have very low surface energy, thermodynamic phase separation exerts an even greater effect.

Moreover, the lamella-forming crystalline polymer applied in the present technology, due to the inherent characteristics of crystalline polymers, exhibits a decrease in viscosity as the temperature increases after reaching the molten state. Additionally, because of its low melt index (MI), the viscosity decreases sharply with increasing shear rate, which further promotes phase separation.

Accordingly, the present invention maintains the temperature of the resin composition below 250 °C during the process, thereby limiting the thermodynamically driven conditions that promote phase separation, reducing the aggregation of pore-forming nanoparticles, and enhancing particle dispersibility, which ultimately improves the uniformity of the pores.

In the resin mixing step, if the shear rate applied to the resin mixture during high-temperature melt mixing is excessively high—i.e., if the equipment is operated at 100 rpm or higher—the temperature of the resin mixture can exceed 250 °C before adequate dispersion is achieved due to the high viscosity of the resin mixture. For example, when the resin mixture is compounded using a typical co-rotating twin-screw extruder operating at 100 to 500 rpm, the temperature of the discharged resin mixture rises to approximately 270 to 290 °C for polyethylene and above 260 °C for polypropylene, making it difficult to achieve proper particle dispersibility.

The resin mixing step uses a pressurized kneader as equipment capable of processing while maintaining the temperature of the resin mixture at 250 °C or below. The pressurized kneader can have various blade configurations depending on the type of material being mixed: a sigma blade (Z Blade) suitable for medium-viscosity materials, a Z blade for pigment dispersion, a double-naben blade (or fish-tail blade) for cellulose, and a masticator blade suitable for ultra-high-viscosity materials. Since the melt viscosity of the particle-introduced lamella-forming polymer mixture is very high, the masticator blade is the most preferred.

As one embodiment, in the resin mixing step, the barrel temperature of the pressurized kneader is maintained at 130 °C to 170 °C, and then the lamella-forming crystalline resin and pore-forming particles are mixed. To achieve uniform dispersion, the material is kneaded for more than 10 minutes after melting, and preferably for more than 15 minutes.

If the shear rate of the pressurized kneader is excessively high, the temperature of the resin mixture may exceed 250 °C before the pore-forming particles are sufficiently dispersed, causing particle aggregation. Therefore, it is important to maintain an appropriate shear rate and kneading time.

Accordingly, in the resin mixing step, the rotational speed (rpm) of the pressurized kneader is 100 or less, preferably 80 or less, and more preferably 50 or less.

Furthermore, if sufficient dispersion can be obtained while maintaining the resin mixture temperature, other equipment may also be used, for example, a Banbury mixer or, in another example, an intermeshing mixer. For instance, in terms of controlling resin temperature and mixing force, a continuous device such as a Planetary Roller Extruder (PRE) may also be used.

The kneaded resin composition is then pelletized through the resin mixture pellet manufacturing step. In this case, the pelletizing equipment may be a conical short-type extruder, for example, a short extruder supplied with raw material via a conical screw, or alternatively, a pelletizing device equipped with a feeder capable of supplying molten material.

The pellets obtained in the resin mixture pellet manufacturing step are used as raw material in the precursor film manufacturing step and extruded to form a precursor film. The extrusion method is not particularly limited; the precursor film may be produced using a single-screw extruder with an annular die in an upcasting or downcasting blown film extrusion system, or a single-screw extruder equipped with a T-die casting system.

In the precursor film manufacturing step, the set temperatures of the single-screw extruder and the annular die are appropriately controlled to maintain the temperature of the resin mixture below 250 °C. For example, the set temperatures of the single-screw extruder can be sequentially set to 215/220/225/230 °C, and the annular die temperature can be set to 240 °C, thereby maintaining the resin mixture temperature at 240 °C during the process. Alternatively, the single-screw extruder set temperatures can be 185/190/195/200 °C, and the annular die temperature can be set to 220 °C to maintain the resin temperature at 220 °C. If the extruder diameter is excessively small, the extruder rotation speed increases, causing the resin temperature to rise, which may negatively affect particle dispersion. Therefore, it is preferable to use an extruder with a larger screw diameter and a lower output rate.

As described above, in the precursor film manufacturing step, when extruding the precursor film using a single-screw extruder, the air pressure within the air bubble is adjusted so that the blow-up ratio is 0.7 to 3.0, and the take-up speed is controlled so that the draw ratio is 50 or greater.

In another embodiment of the precursor film manufacturing step, pellets can be fed into a casting apparatus equipped with a single-screw extruder and a T-die, and the extrudate can be processed onto a casting roll set at (Tm-100)°C to (Tm-10)°C. The extrusion rate and take-up speed are adjusted so that the draw ratio is 50 or greater to produce the precursor film.

If the draw ratio during the precursor film manufacturing step is below 50, uniform pores are difficult to form. A higher draw ratio improves lamella integrity, which is advantageous for pore formation.

The extrusion operation in the precursor film manufacturing step is performed with rapid cooling and rapid draw-down to achieve maximum elasticity. This can be accomplished by keeping the take-up roll close to the extrusion slot, for example within 5 cm, preferably within 3 cm, and rotating as quickly as possible without causing breakage. An air knife may be used within 3 cm of the slot. When using the blown film method, the draw-down ratio is 50:1 or greater, preferably 60:1 or greater, and more preferably 90:1 or greater. The blow-up ratio at this time is 0.7 to 3.0, preferably 0.7 to 2.5, and more preferably 0.7 to 2.0.

Additionally, in the precursor film manufacturing step, the thickness of the precursor film can range from 1 μm to 500 μm, preferably 1 μm to 300 μm, more preferably 1 μm to 100 μm, even more preferably 1 μm to 90 μm, and most preferably 1 μm to 50 μm. If the precursor film becomes thinner than the preferred range, special treatment is required to prevent the film from sticking to the draw roll during the stretching process.

Furthermore, in the precursor film manufacturing step, two or more extruded precursor films may be laminated to produce a multilayer precursor film with two or more layers.

At this time, a multilayer precursor film with two or more layers can be produced using co-extrusion. For a multilayer precursor film with two or more layers, for example, it may have a two-layer structure of lamella-forming crystalline resin/lamella-forming crystalline resin with different contents of pore-forming particles, or a three-layer structure of lamella-forming crystalline resin/lamella-forming crystalline resin/lamella-forming crystalline resin with differing pore-forming particle contents.

In addition, when the precursor film containing pore-forming particles is present on one side, the corresponding second layer or multilayer lamella-forming crystalline resin may not contain any pore-forming particles.

In addition, the annealing step anneals the precursor film, which is formed in the precursor film production step, at a temperature of 90 °C to (Tm-3)°C.

Annealing is a heating process that improves the crystalline and orientation structures through thermal treatment, thereby promoting the formation of fine pores during stretching. When the draw ratio in the precursor film production step is appropriately adjusted to a value of 50 or higher, the annealing process can be shortened. Through the annealing process, the elastic recovery rate of the precursor film can be controlled within a range of 5% to 99%, more specifically 10% to 99%, and even more specifically 20% to 99%. If the elastic recovery ratio is within the above range, pore formation and pore size control in the subsequent stretching process become easy, and it is also easy to implement a morphology including the first pores and second pores, which will be described below. For example, annealing may be performed by placing the precursor film in a rolled form in an oven where thermal convection occurs, by bringing the precursor film into contact with a heated roll or heated metal plate, or by applying heat to the extruded precursor film using hot air or an IR heater in a tenter or the like. The annealing temperature and time may be adjusted according to the stretching ratio during preparation of the precursor film.

For instance, in the case of polypropylene, annealing may be carried out at about 90 °C to 163 °C, or at a temperature from 90 °C up to 3 °C below the melting temperature (Tm) of the crystalline resin.

In addition, the first stretching step stretches the precursor film, which has been annealed in the annealing step, by 5% to 140% at a temperature of 0 °C to 65 °C. Preferably, the stretching is 5% to 140%, more preferably 10% to 130%, and most preferably 20% to 120%.

The first stretching step causes separation between the pore-forming particles and the lamella-forming crystalline resin due to non-uniform stretching, thereby forming fine first pores. As the stretch ratio increases, fine separations of the lamella crystal layers occur around the fine first pores, which induces a more finely divided lamella crystal-fibril structure throughout the entire film than the lamella-fibril structure formed in a uniaxially stretched dry separator, thereby forming uniform second pores. In this process, the film can be stretched in the machine direction (MD) while mounted on a fixed zig, or it can be roll-stretched uniaxially (for example, in the MD direction) using stretching rolls.

If the stretch ratio in the first stretching step is within the range of 5% to 140%, sufficient cracking occurs during the low-temperature stretching process, thereby achieving the desired air permeability and separation properties. When the stretch ratio is less than 5%, deformation occurs only within the elastic deformation region of the precursor composition, so the intended first pores are not formed uniformly. Within the above range, small and uniform pores can be formed across all parts and surfaces of the film. Furthermore, because the tensile force remains below the fracture strength, issues related to film breakage during the stretching process can be avoided. To maintain a low tensile force and prevent breakage, the stretch ratio may be 140% or less, preferably 130% or less, and more preferably 120% or less.

The second stretching step stretches the porous film, which has been stretched in the first stretching step, at a temperature of 80 °C to (Tm-3)°C by 0% to 400%, preferably 0% to 350%, and more preferably 0% to 300%.

When the stretch ratio in the second stretching step is 0%, the pores formed in the lamella-fibril structure during the first stretching are maintained, minimizing pore size, enhancing separation properties, and ensuring adequate air permeability. When the stretch ratio is up to 400%, the slit-like pores are expanded, allowing for suitable maintenance of separation properties while improving air permeability.

As described above, performing the first stretching and second stretching steps separately is more suitable for maintaining uniformity of pores on the film surface.

The heat-setting step heat-sets the porous film, which has been stretched in the second stretching step, at a temperature of 90 °C to (Tm-3)°C.

The heat-setting can include, for example, mounting the film on a fixed zig and stretching it in the longitudinal direction by 0% to 150% while applying heat, then relaxing the stretched precursor to 80% to 100% of its total stretched length. Alternatively, using a roll-type device, the film can be stretched longitudinally by 0% to 150% while heated and then relaxed to 80% to 100% of its total stretched length.

Even if heat-setting is not performed, the separation properties of the membrane are maintained. However, performing heat-setting can produce a porous film with improved dimensional stability. For example, the shrinkage at high temperatures is reduced, thereby enhancing dimensional stability for applications in which the porous separator is subsequently used.

The porous film manufacturing method according to the present invention may further include, after the heat-setting step, a pore-forming particle removal step for removing the pore-forming particles contained in the porous film.

In the pore-forming particle removal step, the pore-forming particles can be removed by immersion in an alkaline or acidic solution, or by dissolving or decomposing organic particles. An appropriate method can be selected for leaching according to the type and characteristics of the particles. To ensure the wettability of the separator, the film may first be wetted with an organic solvent, followed by treatment with a particle-extracting reaction solution in a second step, or the leaching may be performed simultaneously. For inorganic particles, either an alkaline solution or an acidic solution may be used. For example, when hydrophobic silica (SiO₂) is used as the pore-forming particle, the film is immersed in an alkaline solution, whereby the SiO₂ is leached out and removed. As another example, when hydrophobic titanium oxide (TiO₂) is used as the pore-forming particle, the film is immersed in an acidic solution, whereby the TiO₂ is leached out and removed.

The alkaline solution is not particularly limited, but may be an aqueous solution of inorganic alkali. For example, one or more aqueous solutions selected from the group consisting of sodium hydroxide (NaOH), potassium hydroxide (KOH), and calcium hydroxide (Ca(OH)₂) may be used, without being limited thereto. Similarly, the acidic solution is not particularly limited, but may be an aqueous solution of inorganic acid. For example, one or more aqueous solutions selected from the group consisting of sulfuric acid (H₂SO₄), nitric acid (HNO₃), hydrochloric acid (HCl), and phosphoric acid (H₃PO₄) may be used, without being limited thereto. For organic particles, a solvent or decomposing agent capable of dissolving or decomposing the organic particles can be applied for their removal. In this case, the organic particles should be selected in consideration of the subsequent removal step. Examples of usable solvents include acetone, methylene chloride, and the like.

As described above, in the porous film manufactured by the method of the present invention, the number of lamellar crystals in the lamella-fibril structure is formed as a lamellar layer with a layer structure of 7 layers or less, whereas in a conventional dry method porous film, ten or more lamellar crystals may form a single lamellar layer in the lamella-fibril structure.

In another embodiment of the present invention, a separator comprising the porous film manufactured according to the present embodiment can be provided.

The separator may consist solely of the porous film or may further include a porous layer formed on one or both surfaces of the porous film. The porous layer may include a binder resin and/or particles. The porous layer may have adhesion to the porous film. Further, the porous film may or may not have adhesion to the cathode or anode.

In another embodiment of the present invention, an electrochemical cell comprising a separator including the porous film according to the present invention, a cathode, an anode, and an electrolyte can be provided.

The type of electrochemical cell is not particularly limited and may be any type of cell known in the relevant technical field. Specifically, the electrochemical cell according to one embodiment of the present invention may be an alkaline secondary cell, an alkaline-ion secondary cell, an alkaline polymer secondary cell, or an alkaline-ion polymer secondary cell.

More specifically, the electrochemical cell according to one embodiment of the present invention may be a lithium secondary cell such as a lithium metal secondary cell, a lithium-ion secondary cell, a lithium polymer secondary cell, or a lithium-ion polymer secondary cell.

The electrochemical cell according to one embodiment of the present invention may specifically be a lithium secondary cell, such as a lithium metal secondary cell, a lithium-ion secondary cell, a lithium polymer secondary cell, or a lithium-ion polymer secondary cell.

The method for manufacturing the electrochemical cell according to one embodiment of the present invention is not particularly limited, and conventional methods known in the relevant technical field may be employed.

In one implementation example, the electrochemical cell includes an electrode assembly in which a separator is interposed between a positive electrode and a negative electrode, the electrode assembly being wound or stacked, or a positive and negative electrode assembly that is separate, and a case in which the electrode assembly is housed. The positive electrode, negative electrode, and separator are impregnated with an electrolyte.

The positive electrode may include a positive electrode current collector and a positive electrode active material that includes the positive electrode current collector.

The positive electrode may include a positive electrode current collector and a positive electrode active material layer formed on the positive electrode current collector. The positive electrode active material layer may include a positive electrode active material, a binder, and optionally a conductive agent.

The positive electrode current collector may be made of aluminum (Al), nickel (Ni), conductive carbon fiber, or the like, but is not limited thereto

The positive electrode active material may be a compound capable of reversible intercalation and deintercalation of an alkali metal.

The positive electrode active material may be a compound capable of reversible intercalation and deintercalation of lithium. Specifically, one or more compounds selected from composite oxides or composite phosphates of lithium with metals such as cobalt, manganese, nickel, aluminum, iron, or a combination thereof may be used. More specifically, lithium cobalt oxide, lithium nickel oxide, lithium manganese oxide, lithium nickel cobalt manganese oxide, lithium nickel cobalt aluminum oxide, lithium iron phosphate, or a combination thereof may be used.

The binder serves not only to adhere the positive electrode active material particles to one another but also to adhere the positive electrode active material to the positive electrode current collector. Specific examples include polyvinyl alcohol, carboxymethyl cellulose, hydroxypropyl cellulose, diacetyl cellulose, polyvinyl chloride, carboxylated polyvinyl chloride, polyvinyl fluoride, ethylene oxide-containing polymers, polyvinylpyrrolidone, polyurethane, polytetrafluoroethylene, polyvinylidene fluoride, polyethylene-based polymers, polypropylene-based polymers, styrene-butadiene rubber, acrylated styrene-butadiene rubber, epoxy resin, and nylon, but are not limited thereto. These may be used alone or in combination of two or more types.

The conductive agent provides conductivity to the electrode. Examples include natural graphite, artificial graphite, carbon black, carbon fibers, carbon nanotubes, metal powders, and metal fibers, but are not limited thereto. These may be used alone or in combination of two or more types. The metal powders and metal fibers may be composed of metals such as copper, nickel, aluminum, or silver.

The negative electrode may include a negative electrode current collector and a negative electrode active material introduced together with the negative electrode current collector.

The negative electrode may include a negative electrode current collector and a negative electrode active material layer formed on the negative electrode current collector.

The negative electrode current collector may be made of copper (Cu), gold (Au), nickel (Ni), copper alloys, or the like, but is not limited thereto.

The negative electrode active material layer may include a negative electrode active material, a binder, and optionally a conductive agent.

The negative electrode active material may be a material capable of reversibly intercalating and deintercalating lithium ions, lithium metal, an alloy of lithium metal, a material capable of doping and dedoping lithium, a transition metal oxide, or a combination thereof, or it may itself constitute the electrode. Materials capable of reversibly intercalating and deintercalating lithium ions may include carbon-based materials, such as crystalline carbon, amorphous carbon, or a combination thereof. Examples of crystalline carbon include natural graphite or artificial graphite in amorphous, plate-like, flake-like, spherical, or fibrous forms. Examples of amorphous carbon include soft carbon, hard carbon, mesophase pitch carbonized material, and calcined coke. Alloys of lithium metal may include alloys of lithium with metals selected from the group consisting of Na, K, Rb, Cs, Fr, Be, Mg, Ca, Sr, Si, Sb, Ph, In, Zn, Ba, Ra, Ge, Al, and Sn. Materials capable of doping and dedoping lithium may include Si, SiOx (0<x<2), Si—C composites, Si—Y alloys, Sn, SnO₂, Sn—C composites, Sn—Y alloys, or a mixture of at least one of these with SiO₂. The element Y may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and combinations thereof. Examples of transition metal oxides include vanadium oxides and lithium vanadium oxides.

The types of binder and conductive agent used in the negative electrode are the same as those described above for the positive electrode. The positive electrode and negative electrode may each be prepared by mixing their respective active materials and binders, and optionally conductive agents, in a solvent to form electrode compositions, and then applying the respective electrode compositions onto their corresponding current collectors. The solvent may include N-methylpyrrolidone (NMP), but is not limited thereto. Such electrode manufacturing methods are well known in the art, and a detailed description thereof is therefore omitted in this specification.

The electrolyte includes an organic solvent and a lithium salt. The organic solvent serves as a medium through which ions involved in the electrochemical reactions of the battery can migrate. Specific examples of the organic solvent include carbonate-based solvents, ester-based solvents, ether-based solvents, ketone-based solvents, alcohol-based solvents, and non-protic solvents. Examples of the carbonate-based solvents include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), and butylene carbonate (BC). Specifically, when linear carbonate compounds and cyclic carbonate compounds are mixed, a solvent with a higher dielectric constant and lower viscosity can be obtained. In this case, the cyclic carbonate compounds and linear carbonate compounds can be mixed in a volume ratio of 1:1 to 1:9. Examples of the ester-based solvents include methyl acetate, ethyl acetate, n-propyl acetate, dimethyl acetate, methyl propionate, ethyl propionate, γ-butyrolactone, decanolide, valerolactone, mevalonolactone, and caprolactone. Examples of the ether-based solvents include dibutyl ether, tetraglyme, diglyme, dimethoxyethane, 2-methyltetrahydrofuran, and tetrahydrofuran. Examples of the ketone-based solvents include cyclohexanone, while examples of the alcohol-based solvents include ethanol and isopropyl alcohol.

The organic solvent may be used alone or as a mixture of two or more kinds, and when two or more are mixed, the mixing ratio may be appropriately adjusted according to the desired battery performance. The lithium salt is dissolved in the organic solvent and serves as a source of lithium ions within the battery, enabling the basic operation of the electrochemical cell and promoting the movement of lithium ions between the cathode and the anode. Examples of the lithium salt include LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, LiB(C₂O₄)₂, or combinations thereof. The concentration of the lithium salt may be in the range of 0.1 M to 2.0 M. When the concentration of the lithium salt is within this range, the electrolyte exhibits appropriate conductivity and viscosity, resulting in excellent electrolyte performance and effective migration of lithium ions.

### Embodiment(s) of the Invention

The present invention will be described in more detail below with reference to Examples, Comparative Examples, and Experimental Examples. However, these Examples, Comparative Examples, and Experimental Examples are provided solely for the purpose of illustrating the invention, and the scope of the present invention is not limited thereto.

### Example 1

A mixture was prepared by mixing 85 parts by volume of polypropylene (PP S801 [Daehan Yuhwa Co., MI 3.0, stereoregularity 98%, Tm: 166 °C]) with 15 parts by volume of hydrophobic CaCO₃, specifically sodium stearate-modified calcium carbonate (BK07, Dongho Calcium Co.) with an average particle size of 40 nm.

Using a pressurized kneader extruder with a volume of 100 L, mixing was carried out by setting the barrel temperature to 150 °C and the rotation speed to 30 rpm, until the final resin temperature reached 200 °C. After compounding in the Kneader, the material was pelletized using a single-screw extruder equipped with a conical screw feeder and strand cutting method.

The precursor film was melt-extruded using a uniaxial extruder through an annular die (diameter 100 mm, opening 2.5 mm) by the blown-film method at a resin temperature of 200 °C. The barrel temperatures of the extruder were 165/175/185/195 °C, and the die temperature was 195 °C. The extruder had a screw diameter of 70 mm and a length-to-diameter (L/D) ratio of 24:1, and was operated at 25 rpm. The air bubble was maintained at a blow-up ratio (BUR) of 1.4, and the draw ratio was kept between 51 and 60. The resulting film had a width of 200 mm and a thickness of 30-35 μm.

The precursor film was annealed at 130 °C for 30 minutes, followed by 60% cold drawing at 25 °C and 200% hot drawing at 120 °C. The annealing and hot drawing were performed using a zig in a high-temperature oven. After hot drawing, the film was heat-set at 140 °C for 30 minutes. The final thickness of the micro-porous film was between 14 μm and 18 μm.

### Example 2

A mixture having the same composition as in Example 1 was prepared. Except that the mixing time was increased so that the final resin temperature reached 220 °C, compounding and pelletizing were carried out in the same manner as in Example 1. Except that the barrel temperatures of the extruder were set to 185/195/205/215 °C and the temperature of the annular die was set to 215 °C so that the resin temperature reached 220 °C, a precursor film was produced in the same manner as in Example 1, and a microporous film was then prepared in the same manner as in Example 1.

### Example 3

A mixture having the same composition as in Example 1 was prepared. Except that the mixing time was increased so that the final resin temperature reached 240 °C, kneading and pelletizing were carried out in the same manner as in Example 1. Except that the temperatures of the extruder were set to 205/215/225/235 °C and the temperature of the annular die was set to 235 °C so that the resin temperature reached 240 °C, a precursor film was produced in the same manner as in Example 1, and a microporous film was then prepared in the same manner as in Example 1.

### Comparative Example 1

A mixture having the same composition as in Example 1 was prepared. Except that the barrel temperature of the pressure-type kneader (kneader extruder) was set to 250 °C and the mixing was continued until the final resin temperature reached 260 °C, kneading and pelletizing were carried out in the same manner as in Example 1. Except that the temperatures of the extruder were set to 225/235/245/255 °C and the temperature of the annular die was set to 255 °C so that the resin temperature reached 260 °C, extrusion of the precursor film was performed in the same manner as in Example 1, and a microporous film was then prepared in the same manner as in Example 1.

### Comparative Example 2

A mixture having the same composition as in Example 1 was prepared. Compounding was carried out using a co-rotating twin-screw extruder with a screw diameter of 45 mm and an L/D ratio of 40, at 250 rpm, with a feed rate of 50 kg/hr, and extrusion temperatures set to 220/225/230/235 °C, resulting in a resin temperature of 260 °C at the outlet. The extruded strands were cooled in water at 80 °C and then cut to produce pellets. The precursor film was extruded through a single-screw extruder (D=30 mm, L/D=34, where D is the screw diameter and L is the screw length) equipped with a T-slit die having a thickness of 1.8 mm and a width of 400 mm.

The temperatures of the extruder barrels, from the hopper to the die, were set to 220 °C, 230 °C, 240 °C, 250 °C, and 255 °C so that the resin temperature reached 260 °C, and the die temperature was set to 255 °C. The extruder was operated at 150 rpm. A temperature-controlled cooling roll, maintained at 80 °C, was installed 150 mm from the die outlet, and two air knives were used to blow compressed air onto the portion of the extruded melt contacting the cooling roll so that the film could cool while in contact with the roll. The draw-down ratio was maintained at 55, giving the produced film a width of 300 mm after edge trimming and a thickness of 35 μm. A microporous film was then prepared in the same manner as in Example 1.

### Experimental Example 1: Measurement of Gas Permeability of Porous Films

To measure the gas permeability of the porous films from Examples and Comparative Examples, each porous film was mounted in a test chamber with a diameter of 14.5 cm and an area of 165 cm². A pressure of 0.03 MPa was applied to one side of the membrane for 40 seconds. The volume of air that passed through the membrane was collected and measured in milliliters (mL).

At this time, the pressure difference across the separator was measured using a manometer installed with the separator in between, and the pressure was expressed in units of mmH₂O. The measured volume was then divided by the measured pressure. The final unit is ml/mmH₂O (40 sec) (165 cm²).

### Experimental Example 2: Measurement of Porosity of Porous Films

To measure the porosity of the porous films from Examples 1 to 3 and Comparative Examples 1 to 3, the films were wetted using a slow-evaporating liquid. After removing any excess liquid from the surface of the film, the weight of the film was compared to its weight before wetting to calculate the porosity. The liquid used was Tween-80, with a density of 1.078 g/mL.

### Experimental Example 3: Measurement of Surface Pore Ratio of Porous Films

To measure the surface pore ratio of the porous films, FE-SEM images at a magnification of 50,000× were used. The area of the pores on the surface of the sample was measured and divided by the total area of the sample to calculate the surface pore ratio.

### Experimental Example 4: Evaluation of Electrochemical Properties

### [Experimental Example 4-1] Preparation of Battery

For the preparation of the cathode, the active material was LiCoO₂ (KD-10, Umicore) powder at 92 wt %, the conductive agent was carbon black (Super P, TIMCAL) at 4 wt %, and the binder was PVdF (SOLEF 6020, Solvay SA) at 4 wt %. These components were mixed with the solvent NMP and uniformly coated onto an aluminum foil, followed by vacuum drying at 100 °C and compression using a double roll press to increase the packing density, producing the cathode plate. For the anode, the active material was Artificial graphite (SCMG-AR, SHOWA DENKO) at 93 wt %, the conductive agent was carbon black (Super P, TIMCAL) at 2 wt %, and the binder was PVdF (SOLEF 6020, Solvay SA) at 5 wt %. These components were mixed with the solvent NMP, uniformly coated onto a copper foil, and vacuum-dried at 60 °C. The anode plate was then compressed in the same manner as the cathode to increase the packing density. The electrolyte used was an EC/DEC (1:1 v/v) solution containing 1 M LiPF₆, supplied by Panax Etec Co., Ltd.

### [Experimental Example 4-2] Battery Cycle Life Evaluation

For electrochemical evaluation, coin-type full cells were assembled using the separators from Example 1 and Comparative Example 1 under an argon atmosphere. Charge-discharge tests were then carried out using a PEBC050.1 charge-discharge tester (PNE Solution Co.), and the results are shown in FIG. 1.

Considering electrochemical stability, charge-discharge was performed within a voltage range of 3.0-4.2 V. The precycle was carried out at a current rate of 0.1 C, and the cycling performance was evaluated up to 500 cycles at 0.5 C.

The capacity retention was calculated by dividing the remaining capacity after 500 cycles by the initial capacity.

The following Table 1 shows the gas permeability, porosity, and surface pore ratio of the micro-porous films produced according to Examples 1 to 3 and Comparative Examples 1 to 2, as well as the capacity retention (500 cycles) of the lithium-ion batteries produced with these films.

TABLE 1

| | | | | | | | Comp. | | Comp. | |
|---|---|---|---|---|---|---|---|---|---|---|
| | Example 1 | | Example 2 | | Example 3 | | Example 1 | | Example 2 | |
| polymer type | PP | | PP | | PP | | PP | | PP | |
| particle type | CaCO₃ | | CaCO₃ | | CaCO₃ | | CaCO₃ | | CaCO₃ | |
| particle size | 40 | nm | 40 | nm | 40 | nm | 40 | nm | 40 | nm |
| particle | 15 | | 15 | | 15 | | 15 | | 15 | |
| content(Vol %) | | | | | | | | | | |
| PP content(Vol %) | 85 | | 85 | | 85 | | 85 | | 85 | |
| resin kneading | 200 | °C | 220 | °C | 240 | °C | 260 | °C | 260 | °C |
| temperature | | | | | | | | | | |
| rpm during kneading | 30 | | 30 | | 30 | | 30 | | 250 | |
| resin temperature | 200 | °C | 220 | °C | 240 | °C | 260 | °C | 260 | °C |
| during film formation | | | | | | | | | | |
| rpm during film | 25 | | 25 | | 25 | | 25 | | 150 | |
| formation | | | | | | | | | | |
| draw Ratio | 51 | | 51 | | 51 | | 51 | | 55 | |
| crystallization | 130 | °C | 130 | °C | 130 | °C | 130 | °C | 130 | °C |
| temperature | | | | | | | | | | |
| precusor thickness | 35 | μm | 35 | μm | 35 | μm | 35 | μm | 35 | μm |

| | | | | | |
|---|---|---|---|---|---|
| room-temperature | 60% | 60% | 60% | 60% | 60% |
| stretching(25 °C) | | | | | |
| high-temperature | 220% | 220% | 220% | 220% | 220% |
| draw ratio(120 °C) | | | | | |
| porous film thickness | 17.5 | 17 | 17 | 17 | 17 |
| air permeability | 3.1 | 3.1 | 3.1 | 3.2 | 2.9 |
| porosity | 50 | 51 | 50 | 49 | 48 |
| surface porosity | 19 | 19 | 19 | 19 | 18.5 |
| capacity | 79% | 77% | 75% | 59% | 55% |
| retention(500Cy) | | | | | |

As shown in Table 1, when comparing Examples 1 to 3, in which the temperature of the resin mixture was maintained below 250 °C from compounding through precursor film preparation, with Comparative Examples 1 and 2, which were prepared in the same manner as Example 1 except that the resin mixture temperature exceeded 250 °C from compounding through precursor film preparation, the air permeability, porosity, and surface pore ratio of the microporous films were similar. However, in terms of capacity retention after 500 cycles, Comparative Examples 1 and 2, in which the resin mixture temperature exceeded 250 °C, showed 59% and 55%, respectively, whereas Examples 1-3, in which the resin mixture temperature was maintained below 250 °C, exhibited a significantly higher capacity retention of 75% or more. More specifically, Example 1, in which the resin mixture temperature was maintained at 200 °C or below, showed 79% retention; Example 2, maintained at 220 °C or below, showed 77%; and Example 3, maintained at 240 °C or below, showed 75%. These results indicate that the lower the temperature of the resin mixture during compounding and precursor film preparation, the higher the battery capacity retention. This is because, when the resin mixture temperature exceeds 250 °C, aggregation occurs between pore-forming particles, reducing particle dispersion and, consequently, the uniformity of the pores. As demonstrated by the results of the above Examples and Comparative Examples, by maintaining the resin mixture temperature below 250 °C during microporous film formation, particle dispersion can be improved, resulting in enhanced pore uniformity. When such a film is used as a separator in secondary batteries, it significantly improves the battery capacity retention.

Although the present invention has been described with reference to the accompanying drawings and examples, these are merely illustrative, and one skilled in the art would understand that various modifications and equivalent embodiments can be made. Therefore, the technical scope of the present invention should be determined by the following claims.

1. A method for producing a porous film, comprising:
a) a resin mixture manufacturing step of mixing and melting a crystalline resin capable of forming lamellae with pore-forming particles to prepare a crystalline resin mixture containing a pore-forming particle, while maintaining the temperature of the mixture below 250 °C during the mixing and melting;
b) a precursor film manufacturing step of preparing a precursor film containing the pore-forming particle by adjusting the extrusion amount and take-up speed such that the draw ratio is 50 or more, using the crystalline resin mixture prepared in the resin mixture manufacturing step, while maintaining the temperature of the mixture below 250 °C during precursor film manufacturing;
c) an annealing step of annealing the precursor film manufactured in the precursor film manufacturing step at a temperature of 90 °C to (Tm-3)°C;
d) a first stretching step of stretching the annealed precursor film from the annealing step by 5% to 140% at a temperature of 0 °C to 65 °C to produce a porous film;
e) a second stretching step of further stretching the porous film stretched in the first stretching step by 0% to 400% at a temperature of 80 °C to (Tm-3)°C; and
f) a heat-setting step of heat-setting the porous film stretched in the second stretching step at a temperature of 90 °C to (Tm-3)°C,
wherein the resin mixture manufacturing step and the precursor film manufacturing step control the temperature of the mixture to be within the above range.

2. The method of claim 1, further comprising:
g) pore-forming particle removal step of removing the pore-forming particles from the porous film after the heat-setting step.

3. The method of claim 1,
wherein, in the resin mixture manufacturing step, the pore-forming particles are inorganic particles, organic particles, or composite particles.

4. The method of claim 1,
wherein, in the resin mixture manufacturing step, the average particle size of the pore-forming particles is 3 nm to 300 nm or less.

5. The method of claim 1,
wherein, in the resin mixture manufacturing step, the pore-forming particles make up 3 to 30 volume % of the total volume of the crystalline resin mixture containing the pore-forming particles.

6. The method of claim 1,
wherein, in the resin mixture manufacturing step, the crystalline resin capable of forming lamellae is a semi-crystalline polymer.

7. The method of claim 6,
wherein the semi-crystalline polymer is polyethylene or polypropylene.

8. A porous film manufactured by the method of claim 1.

9. A separator for electrochemical cells, manufactured from the the porous film manufactured by the methods of claim 1.

10. An electrochemical cell, comprising a separator, manufactured from the porous film manufactured by the methods of claim 1, cathode, anode, and electrolyte.

11. The electrochemical cell of claim 10,
wherein the electrochemical cell is a lithium secondary battery.
